(19) United States
(12) Patent Application Publication
(10) Pub. No.: US 2017/0212906 A1
(43) Pub. Date: Jul. 27, 2017

(54) INTERACTING WITH USER INTERFACR ELEMENTS REPRESENTING FILES

(71) Applicant: Hewlett- Packard Development Company, L.P., Houston, TX (US)

(72) Inventor: Jinman Kang, San Diego, CA (US)

(21) Appl. No.: 15/329,517

(22) PCT Filed: Jul. 30, 2014
(86) PCT No.: PCT/US2014/048831

§ 371 Date: Jan. 26, 2017

(51) Int. Cl. G06F 17/30; G06F 3/0484; G06F 3/0488

(52) U.S. Cl. CPC G06F 17/30126; G06F 3/0488; G06F 3/04842

(57) ABSTRACT

An example method is described in which files are received by a computer system. A first user interface is displayed on a first display of the computer system. The first user interface includes multiple user interface elements representing the files. In response to detecting a first user gesture selecting a selected user interface element from the multiple user interface elements via the first display, a second user interface is generated and displayed on a second display of the computer system. The second user interface includes a detailed representation of a file represented by the selected user interface element. In response to detecting a second user gesture interacting with the selected user interface element via the first display, the first user interface on the first display is updated to display the interaction with the selected user interface.

### BACKGROUND

Computer systems generally employ a display or multiple displays that are mounted on a support stand and/or incorporated into a component of the computer systems. Users may view files displayed on the displays while providing user inputs using devices such as a keyboard and a mouse.

### BRIEF DESCRIPTION OF DRAWINGS

FIG. 1 is a flowchart of an example process for interacting with user interface elements representing files using a computer system in accordance with the principles disclosed herein;

FIG. 2 is a schematic diagram of an example computer system for interacting with user interface elements representing files using the example process in FIG. 1;

FIG. 3A and FIG. 3B are schematic diagrams of an example first display illustrating ordering of user interface elements based on extracted attribute information;

FIG. 4A and FIG. 4B are schematic diagrams of example interactions using the example computer system in FIG. 2;

FIG. 5 is a schematic diagram of an example local computer system in communication with an example remote computer system when interacting with user interface elements representing files in a collaboration mode;

FIG. 6 is a flowchart of an example process for interacting with user interface elements representing files in a collaboration mode using the example local computer system and remote computer system in FIG. 5; and

FIG. 7 is a schematic diagram of an example computer system capable of implementing the example computer system in FIG. 2 and FIG. 5.

### DETAILED DESCRIPTION

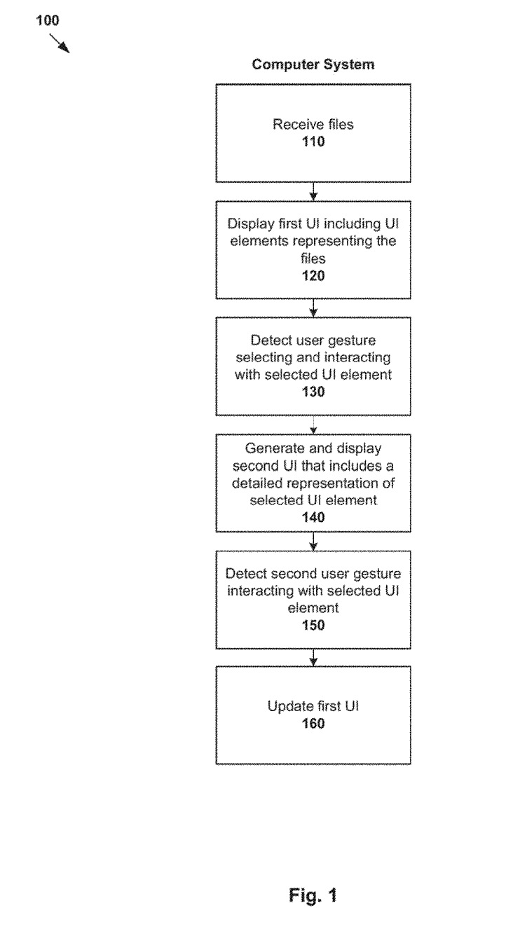

According to examples of the present disclosure, user experience of computer system users may be enhanced by employing multiple displays that facilitate a more intuitive way of interacting with user interface elements representing files. In more detail, FIG. 1 is flowchart of example process 100 for interacting with user interface elements representing files using a computer system. Process 100 may include one or more operations, functions, or actions illustrated by one or more blocks, such as blocks 110 to 160. The various blocks may be combined into fewer blocks, divided into additional blocks, and/or eliminated based upon the desired implementation.

At block 110, files are received by the computer system. According to examples of the present disclosure, the terms “received”, “receiving”, “receive”, and the like, may include the computer system accessing the files from a computer-readable storage medium (e.g., memory device, cloud-based shared storage, etc.), or obtaining the files from a remote computer system. For example, the files may be accessed or obtained via any suitable wired or wireless connection, such as WI-FI, BLUETOOTH®, Near Far Communication (NFC), wide area communications (Internet) connection, electrical cables, electrical leads, etc.

At block 120, a first user interface that includes multiple user interface elements is displayed on the first display of the computer system. The user interface elements represent the files received at block 110.

At block 130, a first user gesture selecting a selected user interface element from the multiple user interface elements is detected. At block 140, in response to detecting the first user gesture, a second user interface is generated and displayed on the second display of the computer system. The second user interface may include a detailed representation of the file represented by selected user interface element.

At block 150, a second user gesture interacting with the selected user interface element is detected. At block 160, in response to detecting the second user gesture, the first user interface on the first display is updated to display the interaction with the selected user interface. The terms “interaction”, “Interact”, “interacting”, and the like, may refer generally to any user operation for any suitable purpose, such as organizing, editing, grouping, moving or dragging, resizing (e.g., expanding or contracting), rotating, updating attribute information, etc.

Example process 100 may be used for any suitable application. For example, the computer system may be used as a media hub to facilitate intuitive and interactive organization of media files, such as image files, video files, audio files, etc. The multiple user interface elements displayed on the first display may be thumbnails of the media files, and the detailed representation may be a high quality representation of the file represented by the selected user interface element (e.g., high resolution image or video).

The terms “user gesture”, “first user gesture”, “second user gesture”, or the like, may refer generally to any suitable operation performed by a user on the first display, or in proximity to the first display, such as a tap gesture, double-tap gesture, drag gesture, release gesture, click or double-click gesture, drag-and-drop gesture, etc. For example, a user gesture may be detected using any suitable approach, such as via a touch sensitive surface of the first display, etc.

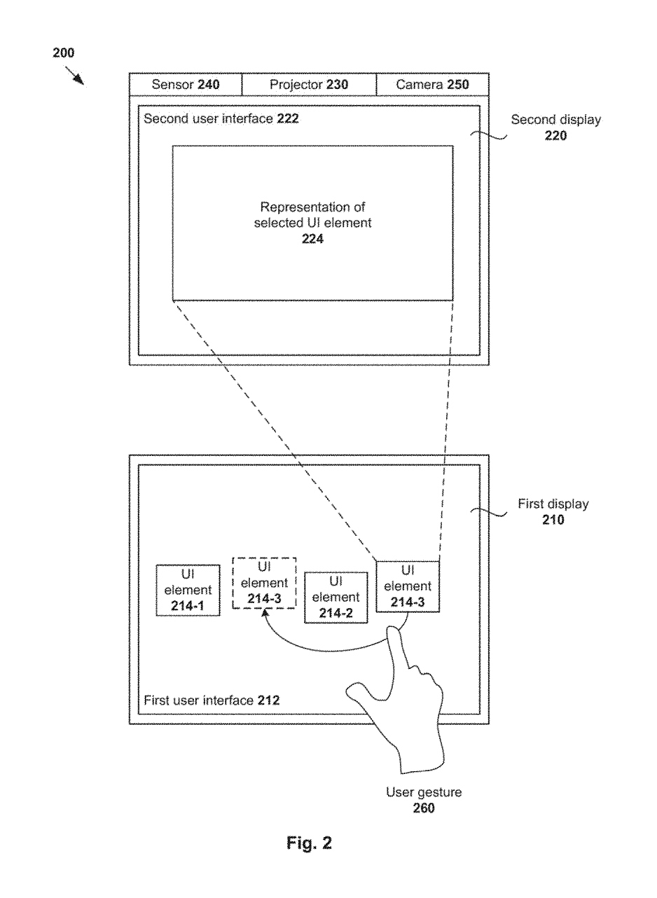

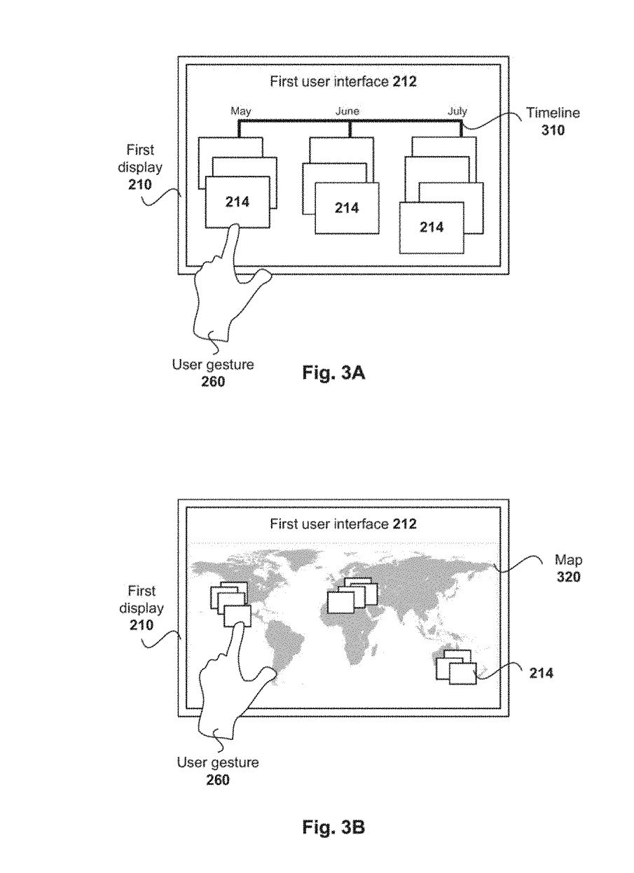

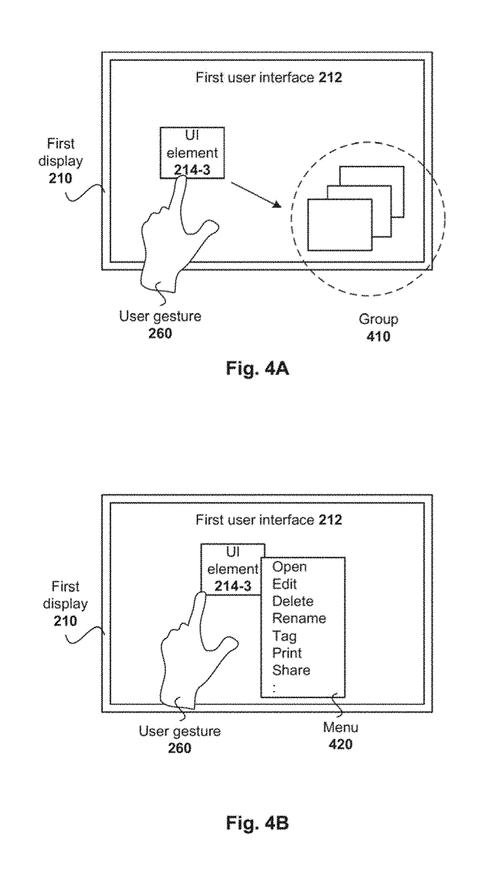

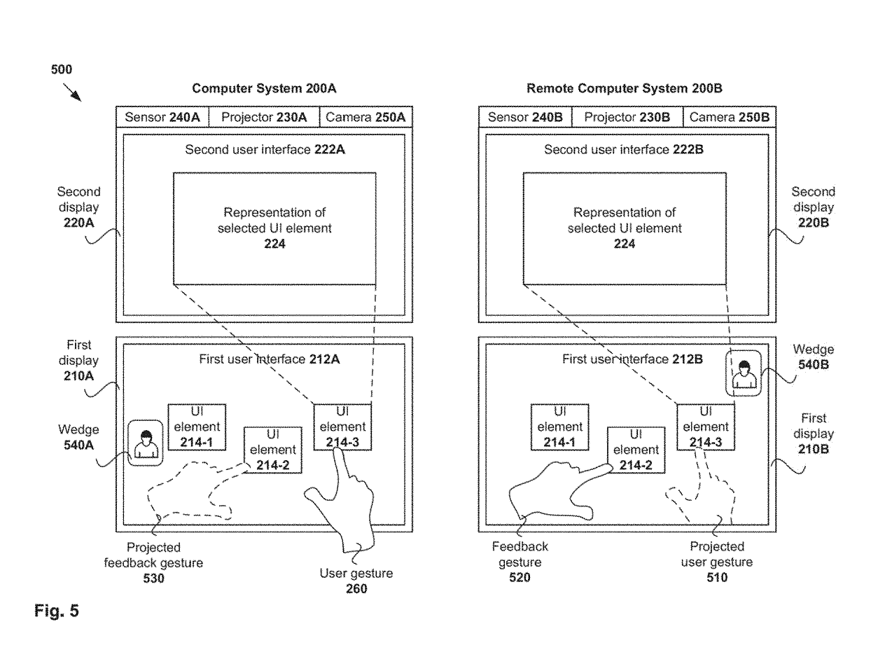

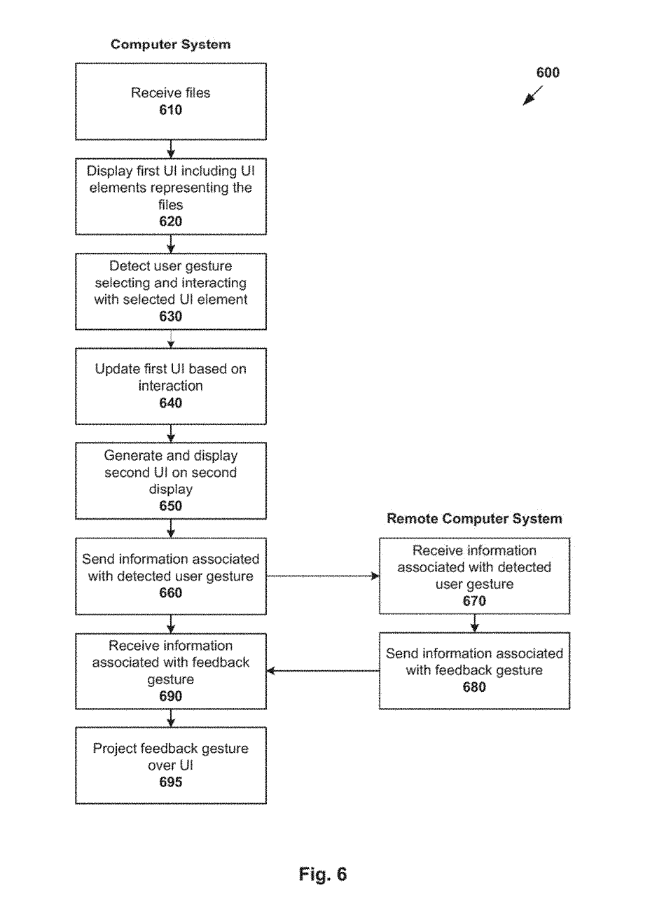

The computer system employing process 100 may be used as in a standalone mode, examples of which will be described in further detail with reference to FIG. 2, FIGS. 3A-3B and FIGS. 4A-4B. To enhance user interactivity and collaborative experience, a collaboration mode may be used to create a shared workspace among multiple users. Examples of the collaboration mode will be described with reference to FIG. 5 and FIG. 6.

Computer System

FIG. 2 is a schematic diagram of example computer system 200 that may implement example process 100 in FIG. 1. Example computer system 200 includes first display 210, second display 220 and any other peripheral units, such as projector 230, sensor unit 240 and camera unit 250. Peripheral units 230 to 250 will be described in further detail with reference to FIG. 4 and FIG. 5. Although an example is shown, it should be understood that computer system 200 may include additional or alternative components (e.g., additional display or displays), and may have a different configuration. Computer system 200 may be any suitable system, such as a desktop system and portable computer system, etc.

To facilitate an ergonomic way for file viewing and interaction, first display 210 and second display 220 may be disposed substantially perpendicular to each other. For example, first display 210 may be disposed substantially horizontally with respect to a user for interaction. In this case, first display 210 may have a touch sensitive surface that replaces input devices such as a keyboard, mouse, etc. A user gesture detected via the touch sensitive surface may also be referred to as a “touch gesture.” Any suitable touch technology may be used, such as resistive, capacitive, acoustic wave, infrared (IR), strain gauge, optical, acoustic pulse recognition, etc. First display 210, also known as a “touch mat” and “multi-touch surface”, may be implemented using a tablet computer with multi-touch capabilities.

Second display 220 may be disposed substantially vertically with respect to the user, such as by mounting second display 220 onto a substantially upright member for easy viewing by the user. Second display 220 may be a touch sensitive display (like first display 210), or a non-touch sensitive display implemented using any suitable display technology, such as liquid crystal display (LCD), light emitting polymer display (LPD), light emitting diode (LED) display, etc.

First display 210 displays first user interface 212, and second display 220 displays second user interface 222. First user interface 212 includes user interface elements 214-1 to 214-3, which will also be collectively referred to as “user interface elements 214” or individually as a general “user interface element 214.” User interface elements 214 may be any suitable elements that represent files and selectable for interaction, such as thumbnails, icons, buttons, models, low-resolution representations, or a combination thereof. The term “selectable” may generally refer to user interface element 214 being capable of being chosen, from multiple user interface elements 214, for the interaction.

In relation to block 120 in FIG. 1, displaying user interface elements 214 may include analysing the files to extract attribute information and ordering them according to extracted attribute information. Any attribute information that is descriptive of the content of files may be extracted based on analysis of metadata and/or content of each file. Metadata of each file may include time information (e.g., time created or modified), location information (e.g., city, attraction, etc.), size information, file settings, and any other information relating to the file.

Content of image or video files may be analysed using any suitable approach, such as using a content recognition engine that employs image processing techniques (e.g., feature extraction, object recognition, etc.). The result of content analysis may be a subject (e.g., a person's face. etc.) or an object (e.g., a landmark, attraction, etc.) automatically recognized from the image or video files. Attribute information of image files with a particular subject may then be updated, such as by adding a tag with the subject's name. Similarly, if a particular landmark (e.g., Eiffel Tower) is recognized, the image files may be tagged with the landmark or associated location (e.g., Paris).

Computer system 200 may then order user interlace elements 214 according to the attribute information. FIG. 3A and FIG. 3B are schematic diagrams of first display 210 in FIG. 2 illustrating ordering of user interface elements 214 based on extracted attribute information. In the example in FIG. 3A, user interface elements 214 are ordered according to time information, such as using timeline 310 with several branches each indicating a particular month the represented image files are created. In the example in FIG. 3B, user interface elements 214 are ordered according to location information, such as using map 320 to w where the represented image files are created.

Although not shown in FIG. 3A and FIG. 3B, user interface elements 214 may also be ordered according to the result of content analysis, such as according to subjects or objects recognized in the image files. For example, if a person's face is recognized in a group of image files, corresponding user interface elements 214 will be displayed as a group. Further, user interface elements 214 may be ordered based on multiple attributes. For example, the ordering may be based on both time and location, in which case first user interface 212 includes multiple time slices of map 320 to represent different times and locations. Any other suitable combination of attribute information may be used.

In the case of user interface elements 214 representing audio files, metadata and/or content of the audio files may also be analysed to automatically extract attribute information such as genre, artist, album, etc. User interface elements 214 of the audio files may then be ordered based on the extracted attribute information (e.g., according to genre, etc.).

User Gestures

Referring to blocks 130 to 140 in FIG. 1 and FIG. 2 again, user interface elements 214 representing files on first display 210 are each selectable for interaction. In response to detecting user gesture 260 selecting user interface element 214-3 (e.g., “first user gesture” at block 130 in FIG. 1), second user interface 222 is generated and displayed on second display 220 to show representation 224 of the file represented by selected user interface element 214-3.

Representation 224 may be a detailed or high quality representation, such as a high resolution image, or a snippet of a video or audio that is played on second display 220. In the example in FIG. 3A, in response to detecting user gesture 260 selecting one of the branches (e.g., “July”) of timeline 310, second user interface 222 may be show high resolution images from the selected branch. Similarly, in the example in FIG. 3B, in response to detecting user gesture 250 selecting a particular location for a more detailed viewing, second user interface 222 may show high resolution images from the selected location.

Further, referring to blocks 150 and 160 in FIG. 1 again, in response to detecting user gesture 260 interacting with selected user interface element 214-3 (e.g., “second user gesture” at block 150 in FIG. 1), first user interface 212 on first display 210 may be updated to display the interaction. In the example in FIG. 2, user gesture 260 is to move selected user interface element 214-3 from a first position (i.e. to the right of 214-2 in FIG. 2) to a second position (i.e. between 214-1 and 214-2 in FIG. 2) during file organization. In this case, first user interface 212 is updated to display the movement.

User gestures 260 may be detected via first display 210 based on contact made by the user, such as using finger or fingers, stylus, pointing device, etc. For example, user gesture 260 moving selected user interface element 214-3 may be detected by determining whether contact with first display 210 has been made at the first position to select user interface element 214-3 (e.g., detecting a “finger-down” event), whether the contact has been moved (e.g., detecting a “finger-dragging” event), whether the contact has ceased at the second position (e.g., detecting a “finger-up” event), etc.

FIG. 4A and FIG. 4B are schematic diagrams of example interactions with the example computer system in FIG. 2. In the example in FIG. 4A, detected user gesture 260 is to select and assign user interface element 214-3 to group 410. For example, group 410 may represent a folder of files, a group of files with common attribute information, or a collection of files that are grouped for any other reason. Once grouped, user gesture 260 may be used to interact with user interface elements 214 in the group simultaneously. Second user interface 222 on second display 220 may also be updated to show detailed representations of files in group 420.

In the example in FIG. 4B, user gesture 260 is to select and update attribute information of the file represented by selected user interface element 214-3. For example, selecting user interface element 2143 may cause menu 420 to appear on first display 210. This allows user to select a menu item, such as “open”, “edit”, “delete”, “rename”, “tag”, “print”, “share” (e.g., with a social networking service), etc., to update any suitable attribute information.

Collaboration Mode

As will be explained with reference to FIG. 5 and FIG. 6, computer system 200 in FIG. 2 may be used in a collaboration mode, such as to create a shared workspace among multiple users. In this case, computer system 200 in FIG. 2 (referred to as “local computer system 200A”) is communicatively coupled to remote computer system 200B to facilitate collaboration among users at different locations. Local computer system 200A and remote computer system 200B may communicate via any suitable wired or wireless communication technology, such as WI-FI, BLUETOOTH®, NFC, ultrasonic, electrical cables, electrical leads, etc.

The terms “local” and “remote” are used herein arbitrarily, for convenience and clarity in identifying the computer systems and their users that are involved in the collaboration mode. The roles of local computer'system 200A and remote computer system 200B may be reversed. Further, the designation of either “A” or “B” after a given reference numeral only indicates that the particular component being referenced belongs to local computer system 200A, and remote computer system 200B, respectively. Although two computer systems 200A and 200B are shown in FIG. 5, it should be understood that there may be additional computer systems, and/or additional users interacting with computer systems 200A and 200B.

FIG. 5 is a schematic diagram of example local computer system 200A and example remote computer system 200B interacting with user interface elements 214 representing files in a collaboration mode. Similar to computer system 200 in FIG. 2, local computer system 200A includes first display 210A displaying first user interface 212A, second display 220A displaying second user interface 222A, projector 230A, sensor unit 240A and camera unit 250A. Remote computer system 200B includes first display 210B displaying first user interface 212B, second display 220B displaying second user interface 222B, projector 230B, sensor unit 240B and camera unit 250B.

When operating in the collaboration mode, users may view the same user interfaces, i.e. local first user interface 212A corresponds with (e.g., mirrors) remote first user interface 212B, and local second user interface 222A with remote second user interface 222B. To enhance user interactivity during the collaboration mode, sensor unit 240A may capture information of user gestures 260 detected at local computer system 200A for projection at remote computer system 200B, and vice versa. This allows the users to provide real-time feedback through projector 230A/230B.

In more detail, sensor unit 240A may capture information of user gesture 260 at local computer system 200A for transmission to remote computer system 200B. Projector 230B at remote computer system 200B may then project an image of detected user gesture 260 onto first display 210B (see “Projected user gesture 510” shown in dotted lines in FIG. 5). Similarly, sensor unit 240B may capture information of feedback gesture 520 at remote computer system 200B for transmission to local computer system 200A.

Projector 230A at local computer system 200A may then project an image of the feedback gesture 520 onto first display 210A (see “Projected feedback gesture 530” in FIG. 5). Projected user gesture 510 and projected feedback gesture 530, which are shown as hand silhouettes in dotted lines in FIG. 5, facilitate real-time discussion and feedback during the collaboration. It will be appreciated that the terns “feedback gesture” may refer generally to any operation performed by a user to provide a feedback in response to detected user gesture 260. For example, feedback gesture 520 may be a hand signal indicating good feedback (e.g., thumbs up), poor feedback (e.g., thumbs down) or simply pointing to an area of first display 210B (e.g., pointing at user interface element 214-2 in FIG. 5).

Sensor unit 240 may include suitable sensor or sensors, such as depth sensor, three dimensional (3D) user interface sensor, ambient light sensor, etc. In some examples, depth sensor may gather information to identify user's hand, such as by detecting its presence, shape, contours, motion, the 3D depth, or any combination thereof. 3D user interface sensor may be used for tracking the user's hand. Ambient light sensor may be used to measure the intensity of light of the environment surrounding computer system 200 in order to adjust settings of the depth sensor and/or 3D user interface sensor, Projector 230A/230B may be implemented using any suitable technology, such as digital light processing (DLP), liquid crystal on silicon (LCoS), etc. Light projected by projector 230 may be reflected off a highly reflective surface (e.g., mirror, etc.) onto first display 210A/210B.

To further enhance interaction during the collaboration, camera unit 250A/250B may be used to capture an image or video of the respective users. The captured image or video may then be projected on a 3D object called “wedge” 540A/540B. “Wedge” may be any suitable physical 3D object with a surface on which an image or video may be projected, and may be in any suitable shape and size. An image or video of the local user at local computer system 200A may be captured by camera 250A arid projected on wedge 540B at remote computer system 200B. Similarly, an image or video of the remote user at remote computer system 200B may be captured by camera 250B, and projected on wedge 540A at local computer system 200A. Wedge 540A/540B may be implemented using any suitable 3D object on which the captured image or video may be projected. In practice, wedge 540A/540B may be moveable with respect to first display 210A/210B, for example to avoid obstructing user interface elements 214 on first user interface 212A/212B. The position of wedge 540A/540B on first display 210A/210B may be localized using sensors (e.g., in sensor unit 240A/240B and/or wedge 540A/540B) for projector 230A/230B to project the relevant image or video.

FIG. 6 is a flowchart of example process 600 for interacting with user interface elements 214 representing files in a collaboration mode using example local computer system 200A and remote computer system 200B in FIG. 5. Example process 600 may include one or more operations, functions, or actions illustrated by one or more blocks, such as blocks 610 to 695. The various blocks may be combined into fewer blocks, divided into additional blocks, and/or eliminated based upon the desired implementation.

At blocks 610 and 620, local computer system 200A receives files and displays first user interface 212A on first display 210A. First user interface 212A includes user interface elements 214 that represent the received files (e.g., media files) and are each selectable for interaction via first display 210A.

At blocks 630 and 640, in response to detecting user gesture 260 selecting and interacting with user interface element 214-3, local computer system 200A updates first user interface 212A based on the interaction. At block 650, local computer system 200A generates and displays second user interface 222B on second display 220B. Second user interface 222B may include representation 224 of selected user interface element 214-3 (e.g., high quality representation). Information associated with the selection and interaction may be sent to remote computer system 200B, which may then update first user interface 212B and/or second user interface 222B accordingly.

At blocks 660 and 670, local computer system 200A sends information associated with detected user gesture 260 to remote computer system 200B. As discussed with reference to FIG. 5, the information associated with detected user gesture 260 may be captured using sensor unit 240A.

At remote computer system 200B, the received information may then be processed and user gesture 260 projected onto first display 210B using projector 230B (see projected user gesture 510 in FIG. 5). This allows the remote user at remote computer system 200B to view user gesture 260 that causes the update of first user interface 212B and/or second user interface 222B. To facilitate real-time remote feedback, remote user may then provide feedback gesture (see 520 in FIG. 2), for example by pointing at a different user interface element 214-2.

At blocks 680 and 690, remote computer system 200B sends information associated with feedback gesture 520 to local computer system 200B. At block 690, local computer system 200A may process the received information to project feedback gesture 520 onto first display 210A using projector 230A (see projected feedback gesture 530 in FIG. 5).

Computer System

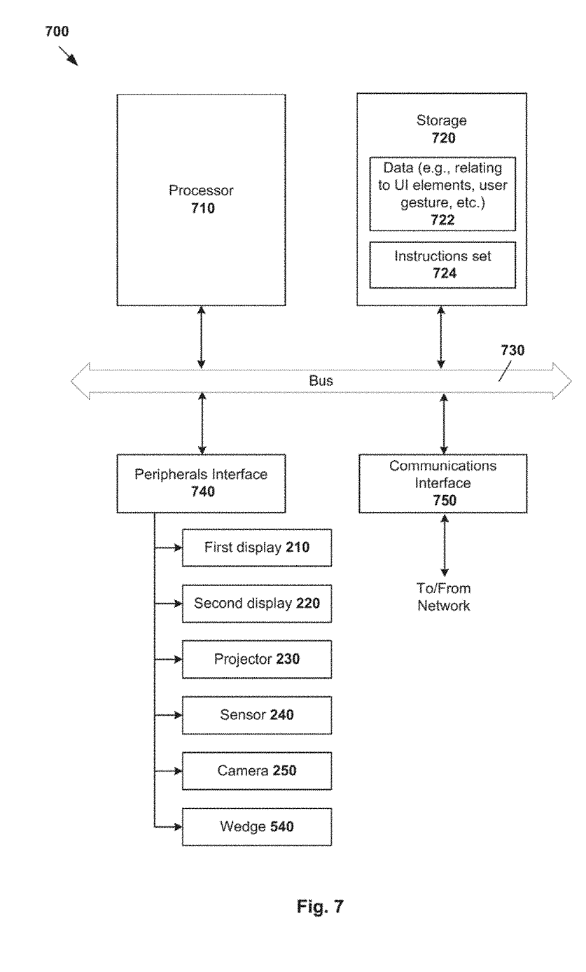

FIG. 7 is a schematic diagram of example computer system 700 capable of implementing computer system 200/200A/220B in FIG. 2 and FIG. 5 Example computer system 700 may include processor 710, computer-readable storage medium 720, peripherals interface 740, communications interface 750, and communications bus 730 that facilitates communication among these illustrated components and other components.

Processor 710 is to perform processes described herein with reference to FIG. 1 to FIG. 6. Computer-readable storage medium 720 may store any suitable data 722, such as information relating to user interface elements 214, user gestures 260/520, etc. Computer-readable storage medium 720 may further store instructions set 724 to cooperate with processor 710 to perform processes described herein with reference to FIG. 1 to FIG. 6.

Peripherals interface 740 connects processor 710 to first display 210, second display 220, projector 230, sensor unit 240, camera unit 250, and wedge 540 for processor 710 to perform processes described herein with reference to FIG. 1 to FIG. 6. First display 210 and second display 220 may be connected to each other, and to projector 230, sensor unit 240, camera unit 250 and wedge 540 via any suitable wired or wireless electrical connection or coupling such as WI-FI, BLUETOOTH®, NFC, Internet, ultrasonic, electrical cables, electrical leads, etc.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware. software, firmware, or virtually any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or firmware to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc). For example, a computer-readable storage medium includes recordable/non recordable media (e.g., read-only memory (ROM), random access memory (RAM), magnetic disk storage media, optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

As used herein, the terms “including” and “comprising” are used in an open-ended fashion, and thus should be interpreted to mean “including, but not limited to . . . ” Also, the term “couple” or “couples” is intended to mean either an indirect or direct connection. Thus, if a first device communicatively couples to a second device, that connection may be through a direct electrical or mechanical connection, through an indirect electrical or mechanical connection via other devices and connections, through an optical electrical connection, or through a wireless electrical connection.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method, comprising:
receiving files by a computer system;
displaying, on a first display of the computer system, a first interface that includes multiple user interface elements representing the files;
in response to detecting a first user gesture selecting a selected user interface element from the multiple user interface elements,
generating and displaying, on a second display of the computer system, a second user interface that includes a detailed representation of a file represented by the selected user interface element; and
in response to detecting a second user gesture interacting with the selected user interface element via the first display,
updating the first user interface on the first display to display the interaction with the selected user interface element.

2. The method of claim 1, wherein the interaction with the first user interface is one of the following:
moving the selected user interface element from a first position to a second position on the first user interface to organize the file represented by the selected user interface element;
assigning the file represented by the selected user interface element to a group of files; and
updating attribute information of the file represented by the selected user interface element.

3. The method of claim 1, wherein:
the files represented by the multiple user interface elements are media files in one of the following formats: image, video and audio;
the multiple user interface elements in the first user interface are thumbnails representing media files; and
the detailed representation in the second user interface is a high quality representation of the file represented by the selected user interface element.

4. The method of claims 1, wherein displaying the first user interface that includes the multiple user interface elements further comprises:
analysing metadata or content, or both, of the files represented by the multiple user interlace elements to extract attribute information of each file; and
based on the extracted attribute information, ordering the multiple user interface elements on the first user interface.

5. The method of claim 1, wherein the attribute information of each file comprises one more of the following:
time information relating to when the represented file is created or modified; location information relating to where the represented file is created, information relating to a subject or an object recognized in the represented file.

6. The method of claim 1, wherein the computer system is communicatively coupled to a remote computer system and the method further comprises:
sending, to the remote computer system, information associated with the detected second user gesture to cause the remote computer system to project the detected second user gesture over a first display of the remote computer system;
receiving, from the remote computer system, information of a feedback gesture of a remote user detected by the remote computer system in response to the detected user gesture; and
projecting, using a projector of the computer system, the feedback gesture over the updated first user interface on the first display of the computer system.

7. A computer system, comprising:
a processor;
a first display having a touch sensitive surface;
a second display; and
an instruction set executable by the processor to:
receive files;
display, on the first display, a first user interface that includes multiple user interface elements representing the files;
in response to detecting, via the touch sensitive surface of the first display, a first touch gesture selecting a selected user interface element from the multiple user interface elements,
generate and display, on the second display, a second user interface that includes a detailed representation of a file represented by the selected user interface element; and
in response to detecting, via the touch sensitive surface of the first display, a second touch gesture interacting with the selected user interface element,
update the first user interface on the first display to display the interaction with the selected user interface element.

8. The computer system of claim 7, wherein the instructions set to display the first user interface is executable by the processor to:
analyse metadata or content, or both, of the files represented by the multiple user interface elements to extract attribute information of each file; and
based on the extracted attribute information, order the multiple user interface elements on the first user interface.

9. A method, comprising:
receiving files by a computer system;
displaying, on a first display of the computer system, a first user interface that includes multiple user interface elements representing the files;
in response to detecting a user gesture selecting and interacting with a selected user interface element from the multiple user interface elements,
updating the first user interface on the first display based on the interaction with the selected user interface element;
generating and displaying, on a second display of the computer system, a second user interface that includes a representation of a file represented by the selected user interface element;
sending, to a remote computer system communicatively coupled with the computer system, information associated with the detected user gesture;
receiving, from the remote computer system, information associated with a feedback gesture of a remote user in response to the detected user gesture; and
projecting, using a projector of the computer system, the feedback gesture over the first user interface on the first display of the computer system.

10. The method of claim 9, further comprising:
capturing, using a camera of the computer system, an image or video of a user providing the user gesture;
sending, to the remote computer system, the captured image or video;
receiving, from the remote computer system, feedback image or video of the remote user providing the feedback gesture; and
projecting, on a wedge of the computer system, the feedback image or video of the remote user.

11. The method of claim 9, wherein:
the files are media files, the multiple user interface elements are thumbnails representing the media files, and the representation on the second user interface is a high quality representation of the media file represented by the selected user interface element.

12. The method of claim 11, wherein the interaction with the selected user interface element is one of the following:
moving the selected user interface element from a first position to a second position on the first user interface to organize the media file represented by the selected user interface element;
assigning the media file represented by the selected user interface element to a group of media files; and
updating attribute information of the media represented by the selected user interface element.

13. A computer system comprising:
a processor;
a first display having a touch sensitive surface;
a second display;
a projector;
a communications interface to communicate with a remote computer system;
and an instructions set executable by the processor to:
receive files;
display, on the first display, a first user interface that includes multiple user interface elements representing the files;
in response to detecting, via the touch sensitive surface of the first display, a touch gesture selecting and interacting with a selected user interface element from the multiple user interface elements,
update the first user interlace on the first display based on the interaction with the selected user interface element;
generate and display, on the second display, a second user interface that includes a representation of a file represented by the selected user interface element;
send, to the remote computer system via the communications interface, information associated with the detected touch gesture;
receive, from the remote computer system via the communications interface, information of a feedback gesture of a remote user in response to the detected touch gesture; and
project, using the projector, the feedback gesture over the first user interface on the display.

14. The computer system of claim 13, further comprising:
a camera;
a wedge; and
the instructions set is executable by the processor to:
capture, using the camera, an image or video of a user providing the touch gesture;
send, to the remote computer system via the communications interface, the captured image or video;
receive, from the remote computer system via the communications interface, a feedback image or video of the remote user providing the feedback gesture; and
project, onto the wedge, the feedback image or video of the remote user.

15. The computer system of claim 13, wherein the instructions set to display the first user interface is executable by the processor to:
analyse metadata or content, or both, of the files represented by the multiple user interface elements to extract attribute information of each file; and
based on the extracted attribute information, order the multiple user interface elements on the first user interface.
